(19) United States
(12) Patent Application Publication
(10) Pub. No.: US 2018/0250999 A1
(43) Pub. Date: Sep. 6, 2018

(54) SUSPENSION SYSTEM AND METHOD FOR CONTROLLING SUSPENSION SYSTEM

(71) Applicant: Tenneco Automotive Operating Company Inc., Lake Forest, IL (US)

(72) Inventor: Michael Golin, Dexter, MI (US)

(21) Appl. No.: 15/972,604

(22) Filed: May 7, 2018

(51) Int. Cl. B60G 17/0165; B60L 11/18; B60G 17/08

(52) U.S. Cl. CPC B60G 17/0165; B60L 11/1829; B60L 11/1833; B60G 17/08; B60G 2800/16; B60G 2500/11; B60G 2800/012; B60G 2800/014; B60G 2800/016; B60G 2204/62

(57) ABSTRACT

A suspension system for a vehicle is provided. The vehicle is travelling on a substrate. The suspension system includes a plurality of dampers and a controller disposed in communication with the plurality of dampers. The controller is configured to determine that a receiving coil disposed on the vehicle is inductively receiving electrical energy from a transmitting coil. The transmitting coil is disposed remote from the vehicle. The controller is further configured to control a damping level of each of the plurality of dampers to maintain a distance between the receiving coil and one of the transmitting coil and the substrate within a predetermined range or at a constant value.

### TECHNICAL FIELD

The present disclosure relates to a suspension system for a vehicle and a method for controlling the suspension system. More particularly, the present disclosure relates to a method for controlling dampers of the suspension system.

### BACKGROUND

Electric vehicles and hybrid vehicles typically include an energy storage unit, such as a traction battery, which provides electrical energy for propulsion. If the energy storage unit is completely or partially discharged, then the vehicle has to stop at a charging station, where the energy storage unit may be recharged. For recharging purposes, the vehicle may have to be connected to the charging station by a cable. This cable connection is typically done manually. It may also be necessary for the charging station and the vehicle to have a compatible cable connection system.

Wireless charging for electric or hybrid vehicles is also known. Wireless charging typically utilizes inductive charging, where one or more transmitting coils are installed in or on an area that can support the vehicle. Furthermore, one or more receiving coils are also arranged in the vehicle. If the vehicle is located above the transmitting coil, the receiving coil and the transmitting coil are inductively coupled with each other. Inductive coupling results in contactless energy transfer from the transmitting coil to the receiving coil. The energy storage unit of the vehicle may be charged by the transferred energy.

An efficiency of inductive energy transfer depends upon a gap or a distance between the receiving coil and the transmitting coil. If the vehicle is travelling during charging, the distance may fluctuate due to various reasons, for example, undulations on the travelled surface, and braking and turning of the vehicle. To maintain a consistent distance between the receiving coil and the transmitting coil, the vehicle may have to be kept in a stationary state or vehicle speed may need to be reduced during charging. The time required for charging may therefore correspond to a downtime for the vehicle. Further, there may be finite number of such charging locations resulting in a waiting time for vehicles.

Given description covers one or more above mentioned problems and discloses a method and a system to solve the problems.

### SUMMARY

In an aspect of the present disclosure, a suspension system for a vehicle is provided. The vehicle is travelling on a substrate. The suspension system includes a plurality of dampers and a controller disposed in communication with the plurality of dampers. The controller is configured to determine that a receiving coil disposed on the vehicle is inductively receiving electrical energy from a transmitting coil. The transmitting coil is disposed remote from the vehicle. Specifically, the transmitting coil is disposed on or below the substrate for generating an inductive signal that may be received by a range of vehicles, each vehicle having a unique ground clearance. The controller is further configured to control a damping level of each of the plurality of dampers to maintain a distance between the receiving coil and one of the transmitting coil and the substrate within a predetermined range or at a constant value.

In another aspect of the present disclosure, a method for controlling a suspension system of a vehicle is provided. The vehicle is travelling on a substrate. Further, the suspension system includes a plurality of dampers. The method includes determining that a receiving coil disposed on the vehicle is inductively receiving electrical energy from a transmitting coil. The transmitting coil is disposed remote from the vehicle. The method further includes controlling a damping level of each of the plurality of dampers to maintain a distance between the receiving coil and one of the transmitting coil and the substrate within a predetermined range or at a constant value.

In an embodiment of the present disclosure, the distance between the receiving coil and the transmitting coil is determined based on signals received from a sensor disposed on the vehicle. In another embodiment of the present disclosure, the distance between the receiving coil and the substrate is determined based on the signals received from the sensor disposed on the vehicle.

In an embodiment of the present disclosure, controlling the damping level of each of the plurality of dampers includes increasing the damping level of each of the plurality of dampers to a predetermined level. In another embodiment of the present disclosure, controlling the damping level of each of the plurality of dampers includes regulating at least one electric valve of a corresponding damper of the plurality of dampers. In a further embodiment of the present disclosure, the damping level of each of the plurality of dampers is controlled independently of each other to optimize a heave, a pitch and a roll of the vehicle.

Other features and aspects of this disclosure will be apparent from the following description and the accompanying drawings.

### BRIEF DESCRIPTION OF DRAWINGS

FIG. 1 is an illustration of a vehicle incorporating a suspension system, according to an aspect of the present disclosure;

FIG. 2 is another illustration of the vehicle of FIG. 1;

FIG. 3 is a schematic view of a system, according to an aspect of the present disclosure;

FIG. 4 is a block diagram of a semi-active shock absorber, according to an aspect of the present disclosure; and

FIG. 5 is a method for controlling a suspension system of a vehicle, according to an aspect of the present disclosure.

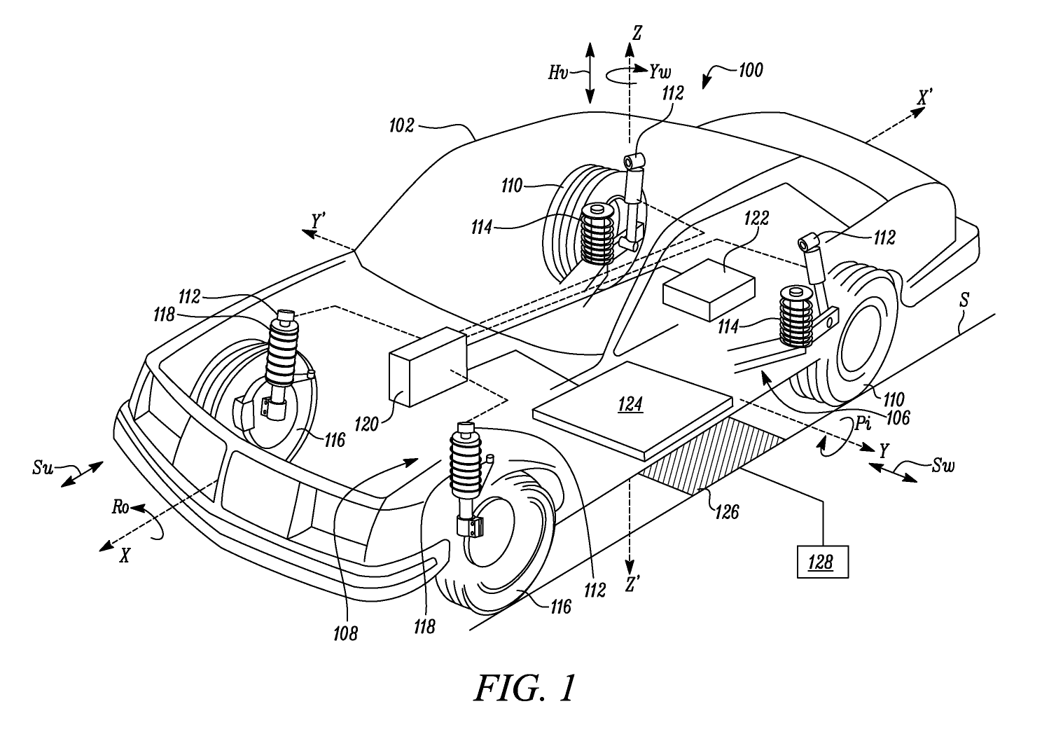

### DETAILED DESCRIPTION

Wherever possible, the same reference numbers will be used throughout the drawings to refer to same or like parts. FIG. 1 illustrates a vehicle 100 incorporating a suspension system in accordance with the present disclosure. The vehicle 100 may be travelling on a substrate “S”. Further, the vehicle 100 includes a body 102. The suspension system of the vehicle 100 includes a rear suspension 106 and a front suspension 108. The rear suspension 106 includes a transversely extending rear axle assembly (not shown) adapted to operatively support a pair of rear wheels 110. The rear axle assembly is operatively connected to the body 102 by means of a pair of dampers 112 and a pair of helical coil springs 114. Similarly, the front suspension 108 includes a transversely extending front axle assembly (not shown) which operatively supports a pair of front wheels 116. The front axle assembly is operatively connected to the body 102 by means of another pair of the dampers 112 and a pair of helical coil springs 118. In an alternative embodiment, the vehicle 100 may include an independent suspension unit (not shown) for each of the four corners instead of front and rear axle assemblies. Each suspension unit may include one or more traction motors. The plurality of dampers 112 of the suspension system 104 serve to damp the relative movement of the unsprung portion (i.e., the front and rear suspensions 108, 106) and the sprung portion (i.e., the body 102) of the vehicle 100. While the vehicle 100 has been depicted as a passenger car, the dampers 112 may be used with other types of vehicles. Examples of such vehicles include buses, trucks, off-road vehicles, and so forth. Furthermore, the term “damper” as used herein will refer to dampers in general and will include shock absorbers, McPherson struts, and passive, semi-active and active suspensions.

In order to automatically adjust each of the dampers 112, an electronic controller 120 (hereinafter referred to as “the controller 120”) is electrically connected to the dampers 112. The controller 120 may be electrically connected to the dampers 112 via wired connections, wireless connections, or a combination thereof. The controller 120 may be an Electronic Control Unit (“ECU”) of the vehicle 100. While the present disclosure is being illustrated with a single controller 120, it is within the scope of the present disclosure to utilize a dedicated electronic controller for each of the dampers 112. The dedicated electronic controller may be located onboard the respective damper 112. The controller 120 is used for controlling an operation of each of the dampers 112 in order to provide appropriate damping characteristics during compression and rebound resulting from movements of the body 102 of the vehicle 100.

FIG. 1 illustrates various types of movements of the body 102 in three dimensions. The movement of the body 102 may be defined with respect to three mutually perpendicular axes “X”, “Y” and “Z”. The axis “X” may be defined as a longitudinal axis of the body 102. The axis “Y” may be defined as a lateral or transverse axis of the body 102. Further, the axis “Z” may be defined as a vertical axis of the body 102. An angular movement or displacement of the body 102 about the axis “X” may be defined as roll “Ro”. Further, a linear movement or displacement of the body 102 along the axis “X” may be defined as surge “Su”. An angular movement or displacement of the body 102 about the axis “Y” may be defined as pitch “Pi”. Further, a linear movement or displacement of the body 102 along the axis “Y” may be defined as sway “Sw”. An angular movement or displacement of the body 102 about the axis “Z” may be defined as yaw “Yw”. Further, a linear movement or displacement of the body 102 along the axis “Z” may be defined as heave “Hv”. The linear and angular movements of the body 102 may occur due to various reasons, such as, but not limited to, undulations (e.g., bumps) of the substrate “S”, braking of the vehicle 102, turning of the vehicle 102, internal vibrations of the vehicle 102, and so forth.

The controller 120 may independently adjust a damping level or characteristic of each of the dampers 112 to optimize a riding performance of the vehicle 100. The term “damping level”, as used herein, refers to a damping force produced by each of the dampers 112 to counteract movements or vibrations of the body 102. A higher damping level may correspond to a higher damping force. Similarly, a lower damping level may correspond to a lower damping force. In an embodiment, the controller 120 may adjust the damping level of each of the dampers 112 to optimize heave “Hv”, pitch “Pi” and roll “Ro” movements of the body 102 of the vehicle 100. In a further embodiment, the controller 120 may control the dampers 112 to optimize surge “Su”, sway “Sw” and yaw “Yw” movements of the body 102. Such adjustments of the damping levels may be beneficial during braking and turning when the vehicle 100 may tend to heave, pitch and roll. In an embodiment, the controller 120 may process input signals from one or more sensors of the vehicle 100 in order to control the damping level of each of the dampers 112. The sensors are disposed in communication with the controller 120 via wired connections, wireless connections, or a combination thereof. Such sensors may sense one or more parameters of the vehicle, such as, but not limited to, heave displacement, heave velocity, heave acceleration, pitch displacement, pitch velocity, pitch acceleration, roll displacement, roll velocity, roll acceleration, vehicle speed, steering wheel angle, brake pressure, engine torque, engine revolutions per minute (RPM), throttle pedal position, and so forth. The controller 120 may further control the damping level of the dampers 112 based on a driving mode of the vehicle 100. The driving mode may include a sport mode or a comfort mode. A button (not shown in FIG. 1) may allow a driver of the vehicle 100 to choose the driving mode of the vehicle 100. The controller 120 may receive input signals based on the actuation of the button and control the dampers 112 accordingly.

In the illustrated embodiment of FIG. 1, the vehicle 100 is an electric car including one or more traction motors (not shown) for propulsion of the vehicle 100. In another embodiment, the vehicle 100 may be a hybrid vehicle. The traction motors may be provided with electrical energy from an energy storage unit 122. In an embodiment, the energy storage unit 122 may be a battery pack having multiple electrochemical cells. The controller 120 may be electrically connected to the energy storage unit 122. Further, the controller 120 may regulate charging or discharging of the energy storage unit 122.

The vehicle 100 further includes a receiving coil 124 disposed on the body 102. In an embodiment, the receiving coil 124 may be provided at a bottom surface of the body 102. In another embodiment, the receiving coil 124 may be disposed within the body 102. The receiving coil 124 may be coupled to the body 102 by various methods, such as fasteners, adhesives, mechanical joints, and so forth. Though, in the illustrated embodiment of FIG. 1, the vehicle 100 includes a single receiving coil 124, the vehicle 100 may include multiple receiving coils within the scope of the present disclosure. The receiving coil 124 is configured to be inductively coupled with a transmitting coil 126. The transmitting coil 126 is disposed remote from the vehicle 100. Specifically, the transmitting coil 126 may be disposed on or below the substrate “S” on which the vehicle 100 is travelling. In an embodiment, the transmitting coil 126 may be embedded within the substrate “S”. The substrate “S” may be any structure that can support the vehicle 100 during travel. In various embodiments, the substrate “S” may be a road, a designated charging area, a bridge or a portion of a building. In an embodiment, multiple such transmitting coils 126 may be provided in the substrate “S” to form a charging zone or area. Further, the transmitting coils 126 may be spaced at regular intervals in the substrate “S”. In an alternative embodiment, a single transmitting coil 126 with suitable dimensions may form a continuous charging area.

The transmitting coil 126 transmits electrical energy to the receiving coil 124 via inductive coupling. Specifically, a change in current in the transmitting coil 126 induces a voltage in the receiving coil 124 through electromagnetic induction. The receiving coil 124 therefore inductively receives electrical energy from the transmitting coil 126. The transmitting coil 126 may be electrically coupled to a power supply 128. The power supply 128 may receive power from a mains power supply. Further, the power supply 128 may include a transformer for increasing or decreasing a voltage associated with the mains power supply. The power supply 128 may further include one or more control components to regulate a power supplied to the transmitting coil 126. In an embodiment, each of the transmitting coil 126 and the receiving coil 124 may include multiple windings of a conductive element. The windings may be provided around a magnetic core made of a ferromagnetic material.

The controller 120 is electrically connected to the receiving coil 124. In an embodiment, the controller 120 may regulate the charging of the energy storage unit 122 by the electrical energy received at the receiving coil 124. One or more components may also be provided between the receiving coil 124 and the energy storage unit 122 to regulate charging of the energy storage unit 122. Such components may include an AC/DC converter, one or more switches, and so forth.

During passage of the vehicle 100 over the substrate “S” including the transmitting coil 126, the controller 120 may determine that the receiving coil 124 is inductively coupled with the transmitting coil 126 based on the induced voltage in the receiving coil 124. The controller 120 may further regulate charging of the energy storage unit 122 by the electrical energy received at the receiving coil 124.

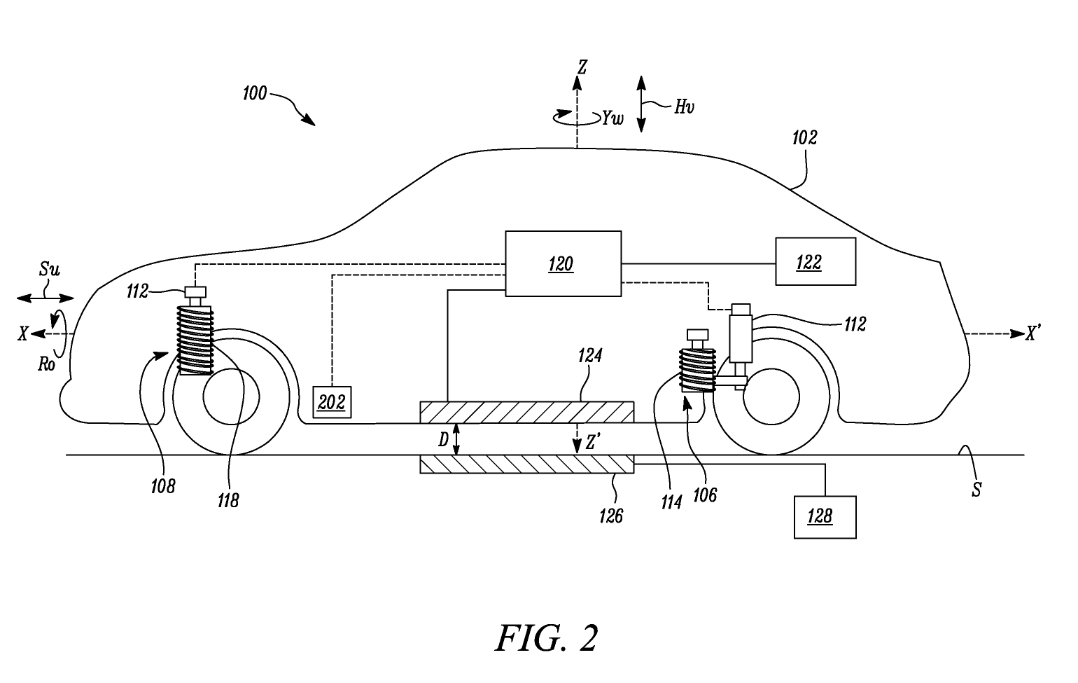

FIG. 2 illustrates another view of the vehicle 100. As illustrated in FIG. 2, the vehicle 100 includes a distance sensor 202 configured to generate signals indicative of a distance “D” between the receiving coil 124 and the transmitting coil 126. In other embodiments, the distance sensor 202 may be configured to generate signals indicative of a distance between the receiving coil 124 and the substrate “S”. In the illustrated embodiment, the distance “D” is also the distance between the receiving coil 124 and the substrate “S”. In various embodiments, the distance sensor 202 may be a radar sensor, a proximity sensor, and the like. Further, the distance sensor 202 is disposed in communication with the controller 120. The distance sensor 202 may be electrically connected to the controller 120 via wired connections, wireless connections, or a combination thereof.

The distance “D” may include an air gap between the transmitting coil 126 and the receiving coil 124. The air gap may determine an efficiency of inductive coupling between the transmitting coil 126 and the receiving coil 124. For maximum coupling efficiency, the distance “D” is to be kept as low as possible. Further, variations in the distance “D” during travel of the vehicle 100 may also vary the coupling efficiency. Such variations in the coupling efficiency may hamper efficient charging of the energy storage unit 122. In an embodiment, the controller 120 controls or regulates the damping level of each of the dampers 112 to maintain the distance “D” between the receiving coil 124 and the transmitting coil 126 within a predetermined range or at a constant value during charging. In another embodiment, the controller 120 may control or regulate the damping level of each of the dampers 112 to maintain the distance between the receiving coil 124 and the substrate “S” within a predetermined range or at a constant value. In a further embodiment, the controller 120 may increase the damping level of each of the dampers 112 to a predetermined level. Increasing the stiffness or the damping level of each of the dampers 112 to the predetermined level may stabilize the suspension system of the vehicle 100 and minimize variations in the distance “D”. This may improve the coupling efficiency between the receiving coil 124 and the transmitting coil 126. Improving the coupling efficiency may result in reduction of power losses during charging. Therefore, the energy storage unit 122 may be efficiently charged. Moreover, maintaining the distance “D” within the predetermined range or at the constant value may at least partly reduce fluctuations in the induced voltage of the receiving coil 124. Consequently, the energy storage unit 122 may be consistently charged.

In an embodiment, the controller 120 may control the damping level of each of the dampers 112 to obtain a target value of the distance “D”. The target value of the distance “D” may be impacted by external road conditions, such as rain, snow, mud and the like. In an embodiment, the controller 120 may control the damping level of each of the dampers 112 based on external road conditions for optimized charging of the energy storage unit 122. The target value of the distance “D” may also be impacted by internal vehicle conditions, such as a charge level of the energy storage unit 122, a fuel level (in case of hybrid vehicles), occupancy of the vehicle 100, and so forth. In a further embodiment, the controller 120 may also regulate the damping level of each of the dampers 112 based on internal vehicle conditions.

An angle between the receiving coil 124 and the transmitting coil 126 may also influence the coupling efficiency. For maximum coupling efficiency, the receiving coil 124 is to be oriented substantially parallel to the transmitting coil 126, i.e., the angle between them is to be kept substantially zero. In an embodiment, the controller 120 may further regulate the damping level of each of the dampers 112 to maintain a planar position of the receiving coil 124 substantially parallel to the transmitting coil 126. In a further embodiment, the controller 120 may control the dampers 112 based on heave “Hv”, pitch “Pi”, roll “Ro”, surge “Su”, sway “Sw” and yaw “Yw” movements of the body 102 so that the receiving coil 124 is oriented substantially parallel to the transmitting coil 126. As a result, the coupling efficiency between the receiving coil 124 and the transmitting coil 126 may be further improved and the energy storage unit 122 is efficiently charged.

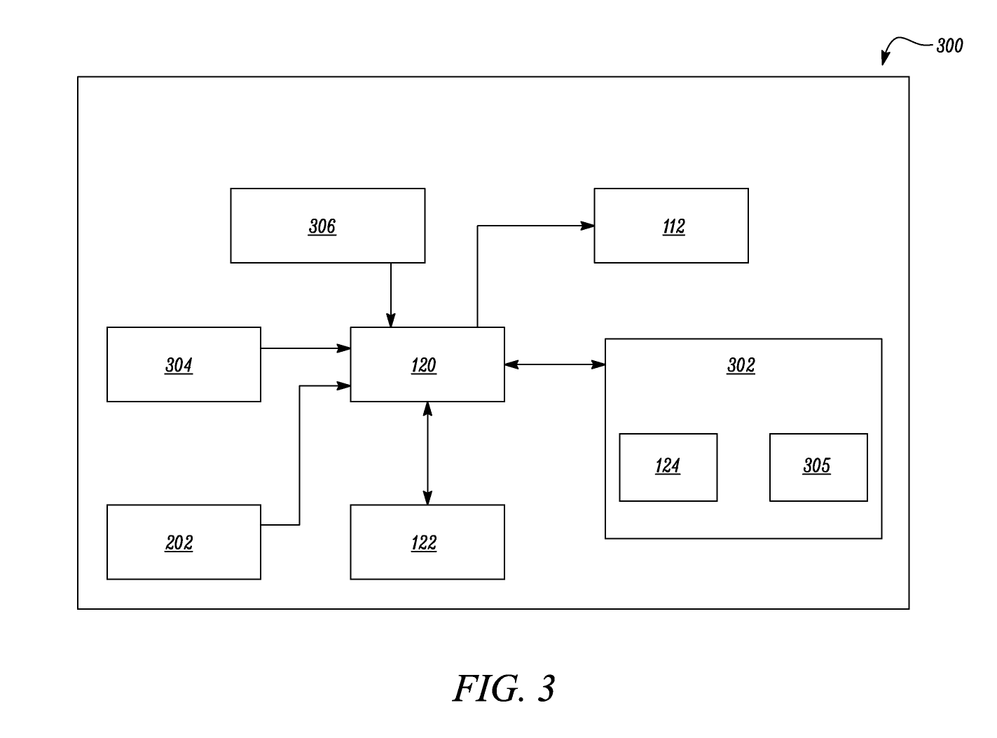

FIG. 3 illustrates a schematic view of a system 300 of the vehicle 100. The system 300 may control the suspension and charging of the vehicle 100. The suspension system of the vehicle 100 includes at least the dampers 112 and the controller 120. The suspension system may further include the distance sensor 202. In the illustrated embodiment, the system 300 includes the controller 120, a charging module 302, the dampers 112, a plurality of sensors 304, the distance sensor 202, a mode button 306 and the energy storage unit 122. Various components of the system 300 may be connected to each other via wired connections, wireless connections, or a combination thereof.

The controller 120 may include a processor, a memory, Input/Output (I/O) interfaces, communication interfaces and other components. The processor may execute various instructions stored in the memory for carrying out various operations of the controller 120. The controller 120 may receive and transmit signals and data through the I/O interfaces and the communication interfaces. In further embodiments, the controller 120 may include microcontrollers, application-specific integrated circuits (ASICs), field programmable gate arrays (FPGAs), and so forth.

The charging module 302 may charge the energy storage unit 122. The charging module 302 is further electrically connected to the controller 120. In an embodiment, the charging module 302 may be electrically connected to the electrical storage unit 122 via the controller 120. In an alternative embodiment, the charging module 302 may be directly connected to the energy storage unit 122. The charging module 302 includes the receiving coil 124 and a converter 305. The converter 305 may be an AC/DC converter that converts the induced AC voltage in the receiving coil 124 to a DC voltage for charging the energy storage unit 122. The charging module 302 may also include additional components, such as switches. The controller 120 may control the operation of one or more components of the charging module 302 in order to regulate charging of the energy storage unit 122. In an embodiment, the energy storage unit 122 may include a lithium-ion battery, a lead acid battery, a nickel metal hydride (NiMH) battery, a capacitor bank and so forth.

The controller 120 further receives input signals from the sensors 304. The input signals may be indicative of various parameters, such as, but not limited to, heave displacement, heave velocity, heave acceleration, pitch displacement, pitch velocity, pitch acceleration, roll displacement, roll velocity, roll acceleration, vehicle speed, steering wheel angle, brake pressure, engine torque, engine revolutions per minute (RPM), throttle pedal position, and so forth. The sensors 304 may include acceleration sensors, displacement sensors, angle sensors, velocity sensors, RPM sensors and the like. The controller 120 also receives input signals from the distance sensor 202 indicative of the distance “D” (shown in FIG. 2) between the receiving coil 124 and the transmitting coil 126. The controller 120 may independently regulate the damping level of each of the dampers 112 based at least on the input signals from the sensors 304 and the distance sensor 202.

The controller 120 also receives input signals from a mode button 306. The mode button 306 may allow a driver of the vehicle 100 to choose the driving mode of the vehicle 100. The controller 120 may receive input signals based on the actuation of the mode button 306 and control the dampers 112 accordingly. The driving mode may include a sport mode or a comfort mode.

During operation of the vehicle 100, the controller 120 may regulate the dampers 112 to optimize heave, pitch and roll of the vehicle 100. Further, the controller 120 may determine that the receiving coil 124 is receiving electrical energy from the transmitting coil 126, and then regulate the dampers 112 to maintain the distance “D” within a predetermined range or at a constant value. The predetermined range may be a target range of the distance “D”. The constant value may be a target value of the distance “D”. In an embodiment, the predetermined range and/or the constant value may depend upon a ground clearance of the vehicle 100. Further, the controller 120 may determine the predetermined range and/or constant value of the distance “D” based on vehicle type. Each type of vehicle may have a different height. For example, a height of a truck is greater than a height of a sports car. Consequently, a target value or a target range of the distance “D” may differ for a truck and a sports car. The controller 120 may determine an optimized damper setting or configuration based on vehicle type in order to minimize power loss.

In an embodiment, each of the dampers 112 may be a continually variable semi-active (CVSA) damper or shock absorber including one or more two-position, on-off electric valves (not shown in FIG. 3). The term “electric valve”, as used herein, refers to an electrically controlled valve. The controller 120 regulates the one or more electric valves of each of the dampers 112 in order to control the damping level of the corresponding damper 112.

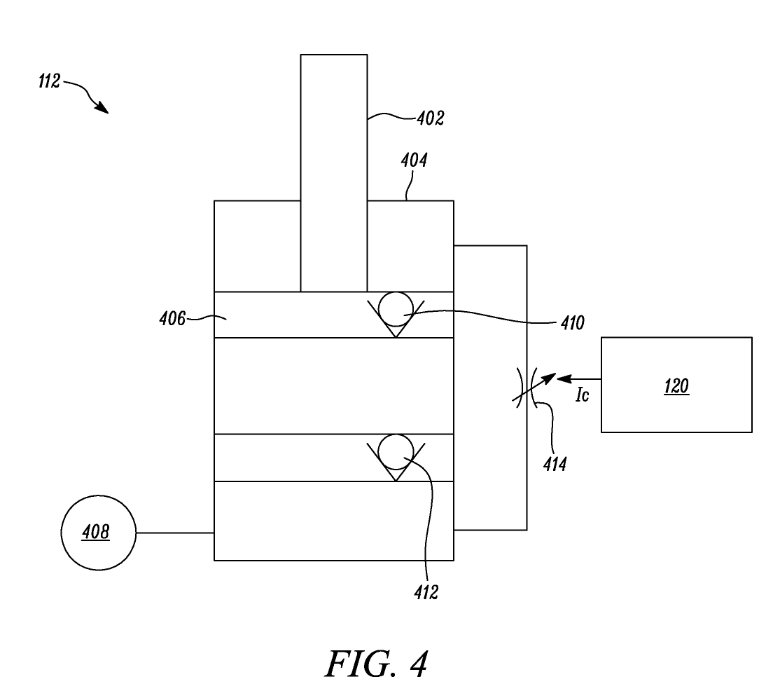

FIG. 4 illustrates a schematic view of the damper 112. The damper 112, as illustrated in FIG. 4, may be any of the four dampers 112 of the vehicle 100. The damper 112 is a CVSA damper or shock absorber including a rod 402, a cylinder 404, a piston 406, an accumulator 408, a piston valve 410, a base valve 412 and an electric valve 414. The cylinder 404 may contain a hydraulic fluid or oil. In an embodiment, the piston valve 410 and the base valve 412 are check valves. In a further embodiment, the electric valve 414 may be a current controlled continually variable semi-active (CVSA) valve. Moreover, the electric valve 414 may be a two-position solenoid valve. The electric valve 414 may be controlled by an input current “Ic” provided to a solenoid (not shown). The solenoid of the electric valve 414 may be in electrical communication with the controller 120. The input current “Ic” may vary between lower and upper limits, which correspond to the least and most restrictive positions (i.e., open and closed positions) of the electric valve 414, respectively. The controller 120 generates the input current “Ic” in order to control the operation of the damper 112.

During operation, when the rod 402 moves up (i.e., rebound), the piston valve 410 closes and oil flows through the electric valve 414. Because the volume of the rod 402 inside the cylinder 404 reduces, oil is forced from the accumulator 408 into the cylinder 404 through the base valve 412.

When the rod 402 moves down (i.e., compression), the piston valve 410 opens. Because the volume of the rod 402 inside the cylinder 404 increases, the base valve 412 closes and oil flows from the cylinder 404 into the accumulator 404 through the electric valve 414.

The controller 120 may control a damping force or level by controlling a degree of restriction of the electric valve 414. Specifically, the controller 120 may regulate the input current “Ic” to vary a restriction of the electric valve 414. A low current to the electric valve 414 may correspond to a small restriction yielding a low damping ratio or damping level. Similarly, a high current to the electric valve 414 may correspond to a large restriction yielding a high damping ratio or damping level. In various embodiments, the controller 120 may use a lookup table, a physical model or a mathematical relationship to regulate the input current “Ic” in order to obtain a desired damping level of the damper 112. For example, if the controller 120 determines that the receiving coil 124 is inductively coupled with the transmitting coil 126, the controller 120 may increase the input current “Ic” in order to increase the damping level of the damper 112 to a desired level. By increasing the damping level or stiffness of the damper 112, the controller 120 may maintain the distance “D” (shown in FIG. 2) between the receiving coil 124 and the transmitting coil 126 within the predetermined range or at the constant value. Further, the controller 120 may independently control the electric valve 414 of each of the dampers 112 in order to independently control the damping level of each of the dampers 112. The controller 120 may also control the electric valve 414 of each the dampers 112 to optimize heave, roll and pitch performance of the vehicle 100 during charging.

The damper 12, as illustrated in FIG. 4, is exemplary in nature and alternate configurations of the damper 112 are possible within the scope of the present disclosure. For example, the damper 112 may include two electric valves (not shown). One of the electric valves may control a flow of oil between an upper chamber located above the piston 406 and the accumulator 408. The other electric valve may control a flow of oil between a lower chamber located below the piston 406 and the accumulator 408.

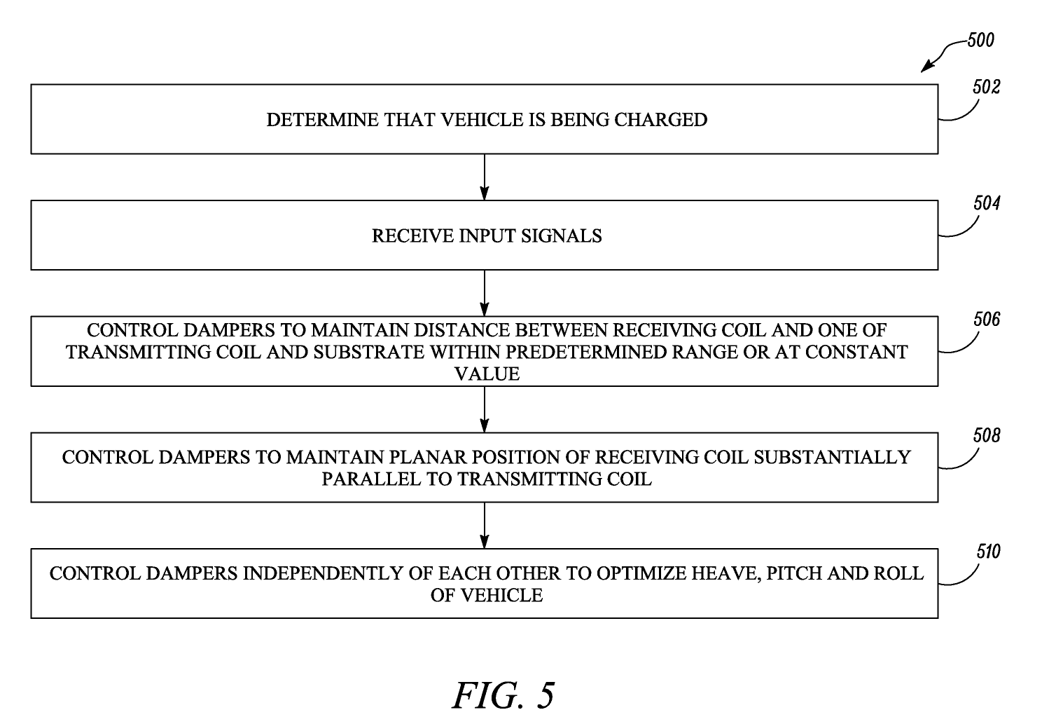

FIG. 5 illustrates a method 500 of controlling the suspension system of the vehicle 100 travelling on the substrate “S” (shown in FIG. 1). At step 502, the controller 120 may determine that the vehicle 100 is being charged. Specifically, the controller 120 may determine that the receiving coil 124 is inductively receiving electrical energy from the transmitting coil 126. In an embodiment, the controller 120 may determine that the receiving coil 124 is receiving electrical energy by detecting a voltage induced in the receiving coil 124 through electromagnetic induction. The controller 120 may then operate the dampers 112 of the vehicle 100 in a charging mode.

At step 504, the controller 120 may receive input signals indicative of various parameters of the vehicle 100 during the charging mode. The parameters may include, but not limited to, heave displacement, heave velocity, heave acceleration, pitch displacement, pitch velocity, pitch acceleration, roll displacement, roll velocity, roll acceleration, vehicle speed, steering wheel angle, brake pressure, engine torque, engine revolutions per minute (RPM), throttle pedal position, driving mode, and so forth. The controller 120 also receives input signals indicative of the distance “D” (shown in FIG. 2) between the receiving coil 124 and the transmitting coil 126 during the charging mode. In another embodiment, the controller 120 may receive input signals indicative of the distance between the receiving coil 124 and the substrate “S” during the charging mode. In an embodiment, the controller 120 receives the input signals from the sensors 304, the distance sensor 202 and the mode button 306. The controller 120 may further determine the distance ‘D” between the receiving coil 124 and the transmitting coil 126 based on the input signals. Alternatively, the controller 120 may determine the distance between the receiving coil 124 and the substrate “S” based on the input signals.

At step 506, the controller 120 controls the damping level of each of the dampers 112 to maintain the distance “D” between the receiving coil 124 and the transmitting coil 126 within the predetermined range or at the constant value. In another embodiment, the controller 120 controls the damping level of each of the dampers 112 to maintain the distance between the receiving coil 124 and the substrate “S” within the predetermined range or at the constant value. In an embodiment, the controller 120 may control the damping level of each of the dampers 112 by regulating the electric valve 414 (shown in FIG. 4) of the corresponding damper 112. The controller 120 may control the damping level of each of the dampers 12 based on the input signals received from the sensors 304, the distance sensor 202 and the mode button 306. In an embodiment, the controller 120 may control the dampers 112 based at least on the vehicle speed and the driving mode of the vehicle 100. In a further embodiment, the controller 120 increases the damping level of each of the dampers 112 to a predetermined level. The predetermined level of damping may stabilize the suspension system of the vehicle 100 and minimize heave “Hv”, pitch “Po” and roll “Ro” motions of the body 102 of the vehicle 100. The predetermined level of damping may further minimize surge “Su”, sway “Sw” and yaw “Yw” motions of the body 102. Consequently, variations in the distance “D” between the receiving coil 124 and the transmitting coil 126 may be minimized during the charging mode. This may improve the coupling efficiency between the receiving coil 124 and the transmitting coil 126. The energy storage unit 122 may therefore be efficiently charged during the charging mode.

At step 508, the controller 120 further regulates the damping level of each of the dampers 112 to maintain a planar position of the receiving coil 124 substantially parallel to the transmitting coil 126. In a further embodiment, the controller 120 may control the dampers 112 based on heave “Hv”, pitch “Pi”, roll “Ro”, surge “Su”, sway “Sw” and yaw “Yw” motions of the body 102 so that the receiving coil 124 is oriented substantially parallel to the transmitting coil 126. As a result, the coupling efficiency between the receiving coil 124 and the transmitting coil 126 may be further improved and the energy storage unit 122 is efficiently charged.

At step 510, the controller 120 may adjust the damping level of each of the dampers 112 independently of each other to optimize heave “Hv”, pitch “Pi” and roll “Ro” movements of the body 102 of the vehicle 100. In a further embodiment, the controller 120 may control the dampers 112 to optimize surge “Su”, sway “Sw” and yaw “Yw” movements of the body 102. Such adjustments of the damping levels may be beneficial during braking and turning when the vehicle 100 may tend to heave, pitch and roll. Specifically, the ride performance of the vehicle 100 may be improved. Further, optimizing the motions of the body 102 may at least partly reduce time-dependent variations in the distance “D” between the receiving coil 124 and the transmitting coil 126. As a result, the coupling efficiency between the receiving coil 124 and the transmitting coil 126 may be improved. In an embodiment, the controller 120 may maintain heave “Hv”, pitch “Pi” and roll “Ro” movements within respective ranges during the charging mode. The controller 120 may also maintain surge “Su”, sway “Sw” and yaw “Yw” movements within respective ranges during the charging mode.

The controller 120 may further determine that the receiving coil 124 is no longer inductively coupled with the transmitting coil 126, i.e., the vehicle 100 has travelled past the transmitting coil 126. The controller 120 may then exit the charging mode and control the dampers 112 as per methodologies applicable to normal travel of the vehicle 100. For example, the controller 120 may return to the driving mode that is preselected by the mode button 306.

The methods and systems of the present disclosure may enable efficient charging of an electric or hybrid vehicle while travelling on a substrate. To enable efficient charging of the vehicle, a distance between a receiving coil arranged on the vehicle and one of a transmitting coil and the substrate may be maintained within a predetermined range or at a constant value. The transmitting coil is disposed remote from the vehicle. Specifically, the transmitting coil is disposed on or below the substrate. The distance between the receiving coil and the transmitting coil or the substrate may be controlled by regulating a damping level of one or more dampers of the vehicle. A planar shape or position of the receiving coil may also be maintained substantially parallel to the transmitting coil. Further, heave, pitch and roll of the vehicle may also be optimized during charging.

Since the vehicle is charged during travelling, a downtime of the vehicle for charging purposes may be prevented or reduced. Moreover, a waiting time of the vehicle in a queue for charging purposes may be prevented or reduced.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A suspension system for a vehicle travelling on a substrate, the suspension system comprising:
a plurality of dampers;
a controller disposed in communication with the plurality of dampers, the controller configured to:
determine that a receiving coil disposed on the vehicle is inductively receiving electrical energy from a transmitting coil disposed remote from the vehicle; and
control a damping level of each of the plurality of dampers to maintain a distance between the receiving coil and one of the transmitting coil and the substrate within a predetermined range or at a constant value.

2. The suspension system of claim 1, further comprising a sensor disposed in communication with the controller, wherein the sensor is configured to generate signals indicative of the distance between the receiving coil and one of the transmitting coil and the substrate.

3. The suspension system of claim 1, wherein each of the plurality of dampers includes one or more electric valves.

4. A method for controlling a suspension system of a vehicle travelling on a substrate, the suspension system having a plurality of dampers, the method comprising:
determining that a receiving coil disposed on the vehicle is inductively receiving electrical energy from a transmitting coil disposed remote from the vehicle; and
controlling a damping level of each of the plurality of dampers to maintain a distance between the receiving coil and one of the transmitting coil and the substrate within a predetermined range or at a constant value.

5. The method of claim 4, further comprising determining the distance between the receiving coil and one of the transmitting coil and the substrate.

6. The method of claim 4, wherein controlling the damping level of each of the plurality of dampers includes increasing the damping level of each of the plurality of dampers to a predetermined level.

7. The method of claim 4, wherein controlling the damping level of each of the plurality of dampers includes regulating at least one electric valve of a corresponding damper of the plurality of dampers.

8. The method of claim 4, further comprising controlling the damping level of each of the plurality of dampers independently of each other to optimize a heave, a pitch and a roll of the vehicle.
